(19) United States
(12) Patent Application Publication
(10) Pub. No.: US 2016/0286897 A1
(43) Pub. Date: Oct. 6, 2016

(54) MOLDABLE FOOTWEAR INSOLE

(71) Applicant: Zero Gravity Inside Inc., National City, CA (US)

(72) Inventor: Patrik Louko, Helsinki (FI)

(21) Appl. No.: 14/675,599

(22) Filed: Mar. 31, 2015

(51) Int. Cl. A43B 17/00; B29D 35/00; A43B 17/14; A43B 7/14; B29D 35/14; A43B 17/02

(52) U.S. Cl. CPC A43B 17/006; B29D 35/14; A43B 17/02; A43B 17/14; A43B 7/14; B29D 35/0009

(57) ABSTRACT

A moldable footwear insole is disclosed. In one aspect, the moldable footwear insole includes a cover layer configured to contact a foot, a foam layer configured to contact a bottom side of the cover layer, a core layer placed below the foam layer, the rigidity of the core layer varying at different locations of the core layer, and a base layer sized and shaped to extend below the core layer. In another aspect, the core layer is formed from a heat-moldable thermoplastic material.

### RELATED APPLICATIONS

This application relates to i) the U.S. Patent Application entitled “Apparatus and Method for Custom Molding an Insole” (Attorney Docket No. ZGI.003A) and ii) the U.S. Patent Application entitled “System and Method for Reproducing Molded Insole” (Attorney Docket No. ZGI.004A) concurrently filed with this application, both of which are incorporated herein by reference.

### BACKGROUND

1. Field

The described technology generally relates to a moldable footwear insole.

2. Description of the Related Technology

A shoe insole or insole refers to an insert with a cushion layer and/or rigid support layer which is fitted into a shoe, Insoles are widely used to provide support and comfort for a user's foot. To provide optimized comfort to a specific foot, custom-made insoles have been developed that conform to the unique and specific shape of a user's foot. In general, custom insoles can be made by molding insoles using a person's feet. These customized insoles are generally more comfortable than mass produced insoles that have been pre-made.

### SUMMARY

The apparatuses and methods of the present disclosure have several features, no single one of which is solely responsible for its desirable attributes. Without limiting the scope of this invention as expressed by the claims that follow, its more prominent features will now be discussed briefly. After considering this discussion, and particularly after reading the section entitled “Detailed Description,” one will understand how the features of this disclosure provide several advantages over other insoles as known in the art.

One inventive aspect is a moldable footwear insole including a cover layer configured to contact a foot, a foam layer configured to contact a bottom side of the cover layer, a core layer placed below the foam layer, the rigidity of the core layer varying at different locations of the core layer, and a base layer sized and shaped to extend below the core layer. In some aspects, the core layer is sized and shaped to extend from below the heel portion of the foot and ends before or below the metatarsophalangeal joints of the foot. In some aspects, the thickness of the core layer varies at different locations of the core layer in the range of approximately 1.0 mm to approximately 3.0 mm. In some aspects, the core layer is made from a heat-moldable or thermoplastic material that is substantially pliable when heated to a temperature in the range of about 120° C. to about 140° C. In some aspects, the heat-moldable or thermoplastic material is a glycol-modified polycyclohexylenedimethylene terephthalate copolymer (PCTG).

In another aspect, a moldable footwear insole includes a foam layer configured to provide cushioning for a foot and a core layer attached to a bottom side of the foam layer, the core layer comprising a heat moldable a glycol-modified polycyclohexylenedimethylene terephthalate copolymer (PCTG). In some aspects, the thickness of the core layer varies in the range of between about 1.0 mm and 3.0 mm at different regions of the core layer. In some aspects, the core layer has a uniform thickness. In some aspects, the thickness of the core layer is selected based upon the weight of the user.

In another aspect, a method for manufacturing a moldable footwear insole includes providing a cover layer including a first side and a second side, the first side configured to contact a foot, placing first side of a foam layer in contact with the second side of the cover layer, placing a core layer below the second side of the foam layer, wherein the thickness of the core layer varies at different locations of the core layer, and covering the core layer with a base layer. In some aspects, the method further includes injection molding the core layer.

### BRIEF DESCRIPTION OF THE DRAWINGS

The above mentioned and other features of this disclosure will now be described with reference to the drawings of several embodiments of the present moldable footwear insole and methods of manufacture thereof. The illustrated embodiments of the apparatuses and methods are intended to illustrate, but not to limit the disclosure. The drawings contain the following figures:

FIG. 1 illustrates a perspective view of an example insole according to one embodiment.

FIG. 2 illustrates an exploded view of example layers that may be used in the insole according to one embodiment.

FIG. 3A illustrates a top view of pair of example insoles according to one embodiment.

FIG. 3B illustrates a bottom view of the pair of insoles shown in FIG. 3A.

FIG. 4A illustrates an example core layer according to one embodiment.

FIG. 4B illustrates the varying thickness of the core layer according to one embodiment.

FIG. 5 is a chart that illustrates how the thickness of the core layer can be selected to provide a proper level of support for users of different weights.

### DETAILED DESCRIPTION

Embodiments will be described with respect to the accompanying drawings. In this disclosure, the term “substantially” includes the meanings of completely, almost completely, or to any significant degree under some applications by those skilled in the art. Like reference numerals refer to like elements throughout the detailed description.

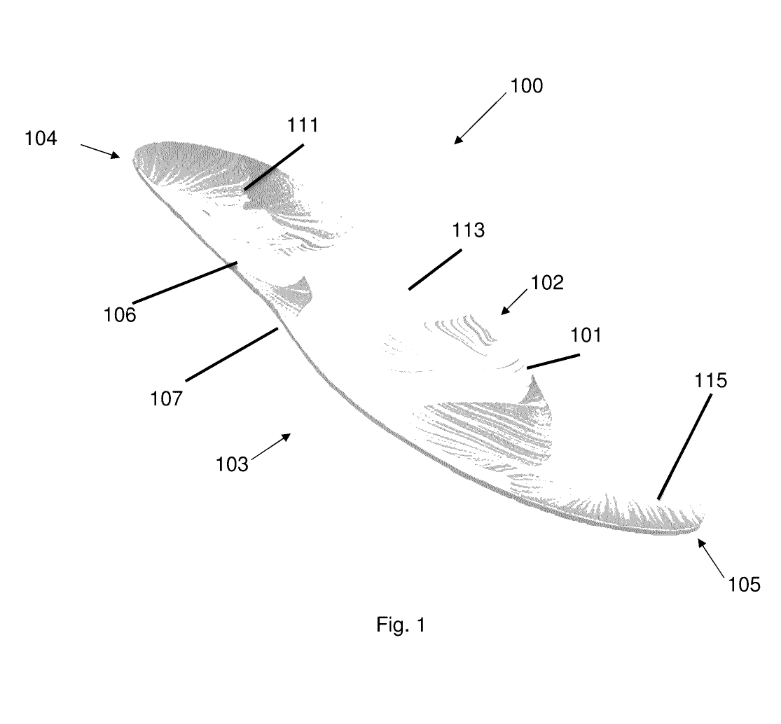

FIG. 1 illustrates a perspective view of an example insole 100 according to one embodiment. The insole 100 can have various structures and configurations as will be described herein.

The insole 100 can be shaped for use with either a right or a left foot. For example, as shown in FIG. 1, the insole 100 is shaped for use with a right foot. The outline of the insole 100, defined by its outer edge 101, may substantially follow the profile of a left or a right foot. In some embodiments, the outer edge 101 is sized and shaped to follow the outline of the insole of a user's shoe so that the insole 100 can be used within the shoe. The insole 100 has a top surface 106 that contacts the bottom surface of a foot and a bottom surface 107 that contacts a shoe during use.

The insole 100 is provided in various sizes for use with different sized feet. In some embodiments, the insole 100 is provided in sizes that correspond to typical men's, women's and children's shoe sizes. The insole 100 may also include one or more portions that are able to be trimmed, so that the size of the insole 100 can be adjusted to match the size of a user's foot or shoe. For example, the edge 101 of the forefoot portion 115 of the insole 100 can be trimmed with scissors to improve the fit.

The insole 100 is moldable, allowing the insole 100 to be configured to match the shape and contours of the bottom surface of a foot. The moldable insole 100 may have a non-molded shape, a molded shape, or a custom-molded shape. A non-molded insole 100 may have a generally flat shape or other general shape. In some embodiments, the insole 100 is manufactured and sold in the non-molded state and can later be molded to fit the shape of the user's foot. A molded insole 100 may have a shape that conforms loosely to the bottom surface of a foot. For example, in some embodiments, the insole 100 is pre-molded by a manufacturer. The pre-molded shape of the insole 100 may allow the insole 100 to be used without further molding or may provide a starting shape from which the insole 100 can be custom molded. A custom-molded insole 100 is an insole 100 that has been molded to specifically conform to the shape of a specific user's foot. In some embodiments, custom- molding the insole 100 involves using the user's foot to mold the insole 100.

As shown in FIG. 1, the insole 100 includes a rearfoot or heel portion 111, a midfoot or arch portion 113, and a forefoot or toe portion 115 as shown. In a molded state, the rearfoot portion 111 corresponds to the heel area of a foot and has a cup like shape that supports the user's heel. The heel cup can curve up from the center of the heel portion 111 towards the edge 101 of the insole 100 along the inside 102, outside 103, and rear 104 of the insole 100. The heel cup can curve upward, although to a lesser extent, towards the transition from the heel portion 111 to the midfoot portion 113 of the insole 100. The midfoot portion 113 corresponds to a middle region of the foot extending from an end of the heel area of the foot to a region where the metatarsophalangeal joints are located. The midfoot portion 113 includes features shaped to support the arch of a foot. Accordingly, the midfoot portion 113 can curve up towards both the inside 102 and outside 103 edges 101 of the insole 100, with a generally larger rise on the inside 102 of the insole 100 that corresponds to the foot's arch. The forefoot portion 115 of the insole 100 corresponds to an area extending from the metatarsophalangeal joints to the ends of the toes of the foot and is generally flat. The insole 100 may be made from one or more layers and the supportive shape of the insole 100 can be provided by one or more rigid core layers.

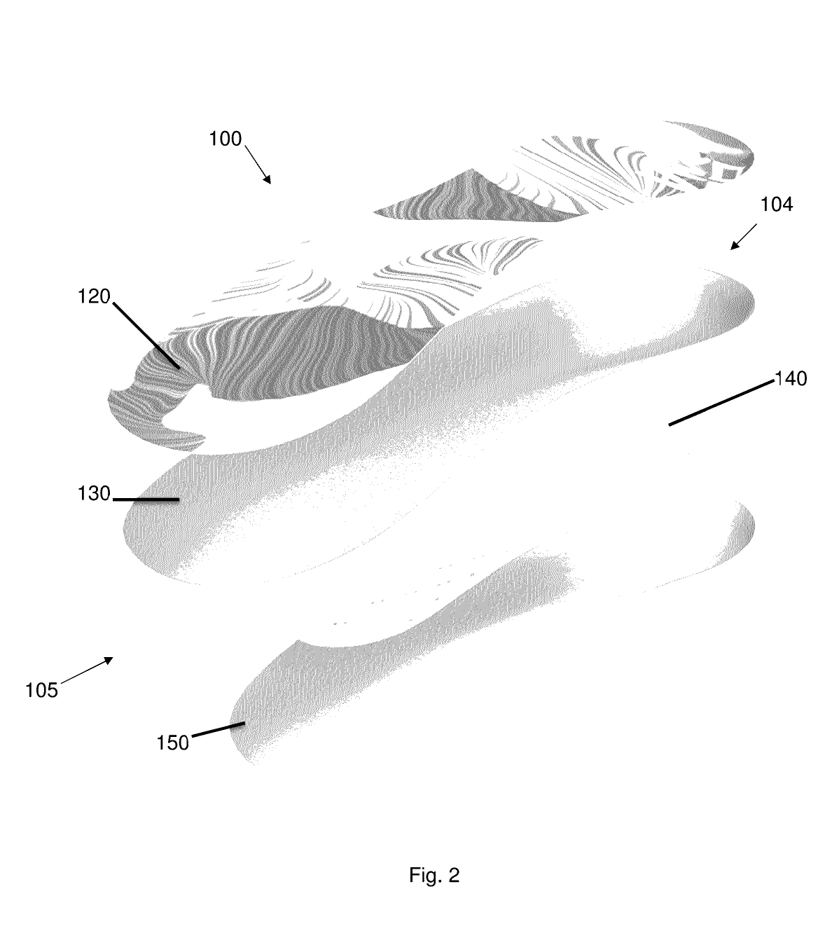

FIG. 2 illustrates an exploded view of example layers that may be used in the insole 100 according to one embodiment. The insole 100 includes a cover layer 120, a foam or cushion layer 130, a core layer 140, and a base or foundation layer 150. Although FIG. 2 shows the various layers in an exploded state for ease of description, when the insole 100 is assembled, each layer is bonded to the adjacent layers by, for example, a thin layer of adhesive. The cover layer 120 is placed on top of the foam layer 130, the foam layer 130 is placed on top of the core layer 140, and the core layer 140 is placed on top of the base layer 150.

The cover layer 120 can be made from a thin, durable, and flexible material, for example, a cloth material. In some embodiments, the cloth material is polyester woven fabric or cotton. In some embodiments, the cover layer 120 is also antibacterial. For example, the cover layer 120 can be saturated in, sprayed with, or otherwise impregnated or coated by an antibacterial solution. Or, for example, the cover layer 120 can be made of a nano-silver particle fabric, which is itself antibacterial. Depending on the particular embodiment, the cover layer 120 can be in the range of approximately 230 mm to approximately 360 mm long, measured from the rear 104 to the front 105 of the cover layer 120, and can be in the range of approximately 60 mm to 115 mm wide measured across the widest portion of the cover layer 120 from the inside 102 to the outside 103 of the cover layer 120. However, other lengths and widths of the cover layer 120 are possible. The cover layer 120 interfaces with the bottom of the foot during use of the insole 100.

The foam layer 130 can be made from a material that provides cushioning, for example, ethylene vinyl acetate (EVA) foam. In some embodiments, the foam layer 130 is made from a material that provides good breathability to increase the comfort of the insole 100 during use. The foam layer 130 can have substantially the same length, width, and profile shape as the cover layer 120. The foam layer 130 may have a thickness in the range of about 0.5 mm to about 7 mm. In some embodiments, the foam layer 130 has a thickness in the range of between about 2 mm to about 5 mm. For example, the foam layer 130 may be approximately 4 mm thick, although other thicknesses, either thinner or thicker, may be used.

The core layer 140 provides the structural shape of the insole 100 and allows the insole 100 to be moldable. The core layer 140 can be made from a heat-formable or thermoplastic material, such as a glycol-modified polycyclohexylenedimethylene terephthalate copolymer (PCTG), or other suitable material, that is substantially rigid throughout a range of temperatures at which the insole 100 will be used, for example, the range of temperatures typical within a user's shoe, and substantially pliable or moldable throughout a range of temperatures that will be used during a molding process, for example, temperatures in the range of about 120° C. to about 140° C. The core layer 140 thus provides the rigid structure for the insole 100 while in use, while also allowing the insole 100 to be moldable if heated to a temperature at which the core layer 140 becomes pliable. In some embodiments, the core layer 140 is made from PCTG, ABS, PVC, A-PET, or PETG.

Depending on the specific embodiment, the core layer 140 has a length between about 145 mm and about 215 mm, although other lengths for the core layer 140 are also possible. The core layer 140 is also generally narrower in width than the cover layer 120 and/or the foam layer 130, although, the core layer 140 may be as wide as the cover layer 120 and/or the foam layer 130. The core layer 140 may weigh in the range of between about 25 g and about 75 g, although heavier or lighter core layers 140 are also possible. The core layer 140 may include additional features that will be described in greater detail below.

The base layer 150 can be made from a thin, flexible, and durable material, for example, a cloth material. The base layer 150 is sized and shaped to cover the core layer 140. Accordingly, the base layer 150 may have a length in the range of between the length of the foam layer 130 and the length of the core layer 140, and a width in the range of between the width of the foam layer 130 and the width of the core layer 140.

Although the insole 100 has been described as having four layers, in some embodiments, one or more of the above-described layers may be omitted or one or more of the above-described layers may be realized as a plurality of layers. For example, the insole 100 includes only the foam layer 130 and the core layer 140. Or, the insole 100 can include a foam layer 130 that includes two or more individual layers of foam. In some embodiments, the insole 100 includes only a single layer. In some embodiments, the single layer is the core layer 140.

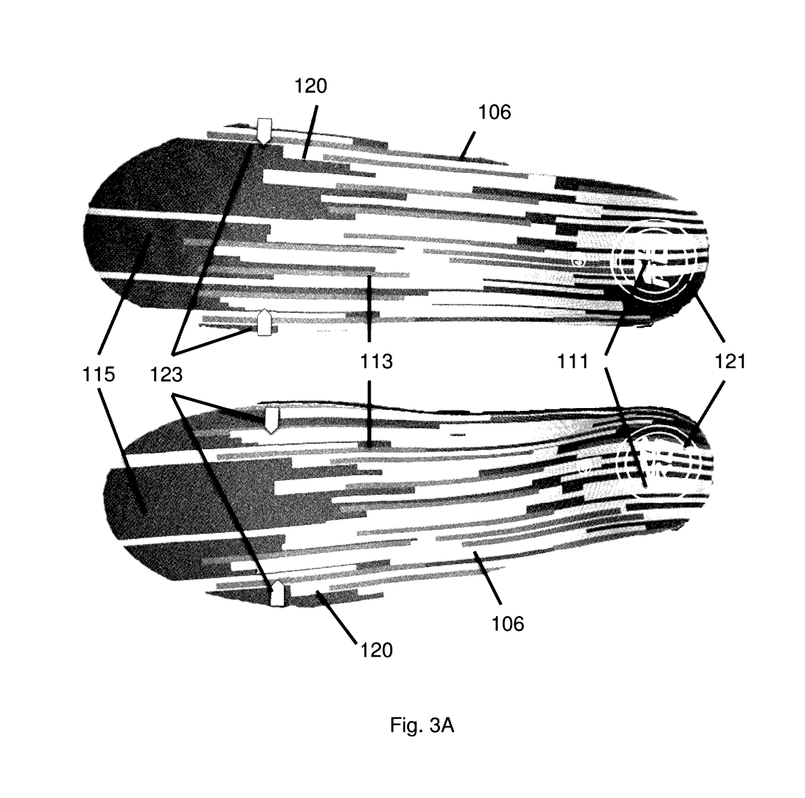

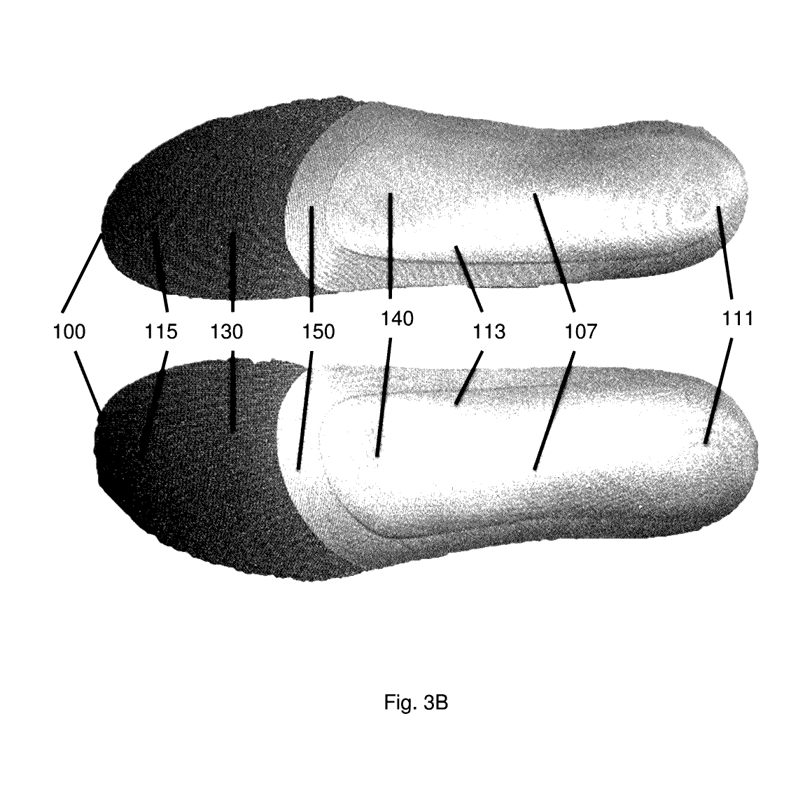

FIG. 3A illustrates a top view of pair of example insoles 100 according to one embodiment. The cover layer 120 can substantially cover the entire top surface 106 of each insole 100. The cover layer 120 can extend the entire length of each insole 100 from the rear portion 111, through the midfoot portion 113, to the end of the forefoot portion 115. As seen in FIG. 3, the top surface 106 of each insole 100 includes one or more heel alignment guides 121 shown positioned on the rear portion 111 of the cover 120. The heel alignment guides 121 may be used to aid positioning the user's foot during molding. The top surface 106 of each insole 100 also includes one or more front alignment guides 123 that may be used to aid positioning of the insole 100 on a molding device, for example, the molding device described in the U.S. Patent Application entitled “Apparatus and Method for Custom Molding an Insole” (Attorney Docket No. ZGI.003A) that is concurrently filed herewith and is incorporated herein by reference.

FIG. 3B illustrates a bottom view of the pair of insoles 100 shown in FIG. 3A. The bottom surface 107 of each insole 100 includes a portion of a bottom surface of the foam layer 130 and substantially the entirety of the base layer 150. The outline of the core layer 140, which is positioned between the foam layer 130 and the base layer 150, can also be seen in FIG. 3B. As shown, the base layer 150 substantially covers the core layer 140. The core layer 140 and the base layer 150 are positioned in the rearfoot portion 111 and the midfoot portion 113 of the insole 100. The core layer 140 and the base layer 150 extend below the rear portion 111 through the midfoot portion 113 and end at approximately below the metatarsophalangeal joints of the foot. However, the core layer 140 and the base layer 150 may extend either to a smaller or larger portion of the insole 100 in some embodiments.

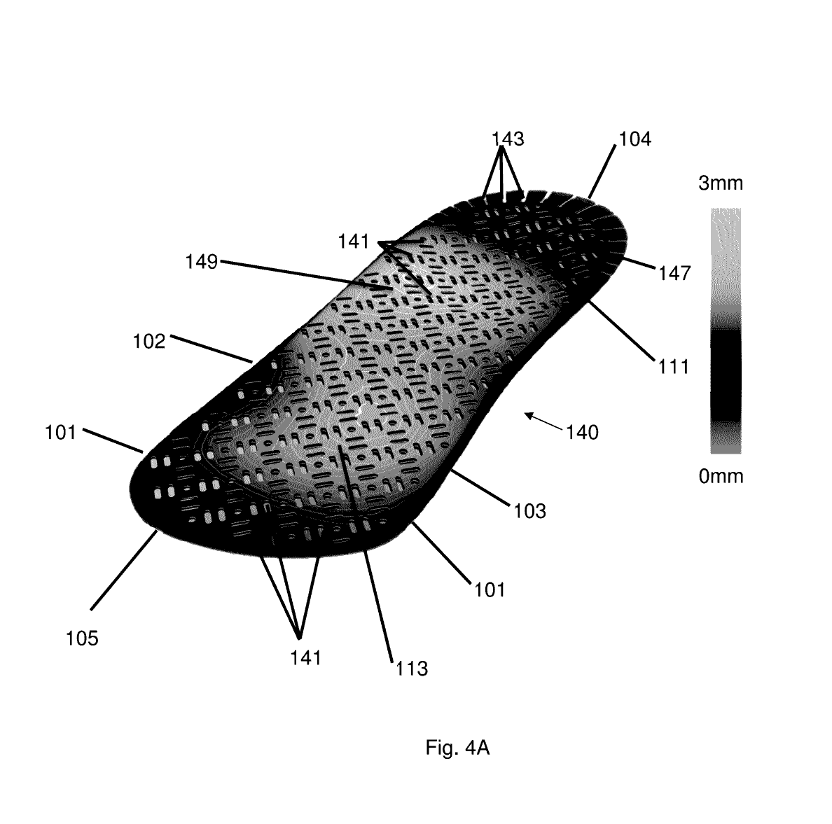

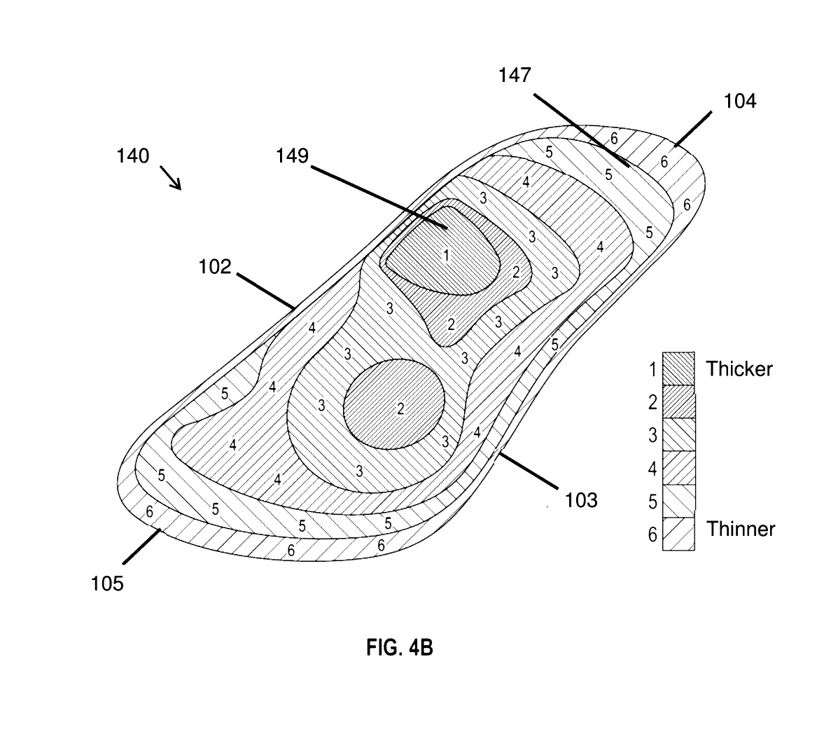

FIG. 4A illustrates an example core layer 140 according to one embodiment. In some embodiments, the core layer 140 described above may optionally include the additional elements and features described here.

In FIG. 4A, the core layer 140 has a thickness that varies in the range of approximately 0.5 mm and approximately 10 mm at various areas along the width and length of the core layer 140. In some embodiments, the thickness of the core layer 140 varies in the range of between about 0.5 mm and 4.0 mm. In some embodiments, the core layer 140 varies in the range of between about 2.5 mm and 1.3 mm. In FIG. 4, the shading of a specific portion of the core layer 140 indicates a particular thickness for that portion of the core layer 140. The thickness can be determined by comparing the shading of the portion of the core layer 140 to the scale provided in the figure. As shown, the core layer 140 is thinner toward the rear 104 of the rearfoot portion 111 and the front 105 of the midfoot portion 113. The core layer 140 is thicker towards its center portion (between the rear portion 111 and the midfoot portion 113) and, in particular, in the region of the arch support toward the inside 102 of the core layer 140. For example, the heel cup 147 in the rearfoot portion 111 of the insole 100 is approximately 0.8 mm thick, and the arch support region 149, in the midfoot portion 113 of the insole 100, is approximately 3.0 mm thick. The varying thicknesses of the core layer 140 give the core layer 140 a variable or dynamic stiffness or rigidity that provides different levels of support to different parts of the foot as needed. For example, the core layer 140 provides more support for the arch of a foot and less support for the heel.

FIG. 4B also illustrates the varying thickness of the core layer 140 according to one embodiment. In the figure, the core layer 140 is divided into zones corresponding to thicker and thinner regions of the insole, as shown in the corresponding scale. It will be appreciated, that in some embodiments, the transition in thickness between adjacent zones is gradual. That is, in some embodiments, the thickness varies smoothly across the core layer 140. Moreover, it will be appreciated that the zones depicted in FIG. 4B are provided by way of example only. It is possible that the core layer 140 include different arrangements of thicker and thinner zones.

In the embodiment of FIG. 4B, the core layer 140 is thickest, and therefore provides the most rigid support, at an arch support region 149. The core layer 140 is thinnest along the edges 101, and especially at the rear 104 and front 105 of the core layer 140. Accordingly, the core layer 140 may provide a more flexible support to the user's heel at the heel cup 147.

The variable thickness feature described above is optional. In some embodiments, the core layer 140 has a uniform thickness across its length and width. A core layer 140 with a uniform thickness may have a variable rigidity by manufacturing certain portions of the core layer 140 from materials with different rigidities. For example, a more rigid material is used at the arch support region of the core layer 140 and a less rigid material is used at the rearfoot portion 111 of the core layer 140.

The edges 101 of the core layer 140 may taper from the thickness of the core layer 140 down to a fine point. This may produce a substantially ridge free design that may reduce chaffing or abrasions caused by the use of the insole 100. The tapered edges 101 of the core layer 140 can seamlessly fuse the core layer 100 into the adjoining layers (the cushion layer 130 above and the base layer 150 below).

As shown in FIG. 4A, the core layer 140 may be perforated with a plurality of small holes 141 passing through the core layer 140. The small holes 141 provide ventilation through the core layer 140 that increases the comfort and breathability of the core layer 140. The small holes 141 also reduce the weight of the core layer 140 and the overall weight of the insole 100. The small holes 141 can be arranged evenly, in a pattern, or unevenly on the core layer 140. The small holes 141 may be circular with a diameter ranging between 0.5 mm and 3.0 mm. In some embodiments, the small holes 141 are formed as other shapes, for example, ovals.

The small holes 141 may be clustered in varying densities to create a variable rigidity for the core layer 140. For example, fewer small holes 141 in a certain portion of the core layer 140, for example, the arch support portion, can create a more rigid structure at that location. More small holes 141 clustered in a certain portion of the core layer 140, for example the rearfoot portion 111, can create a less rigid structure at that location. In another embodiment, the size of the small holes 141 varies to create a more or less rigid portion of the core layer. For example, larger holes 141 may cause that portion of the core layer 140 to be less rigid, and smaller holes 141 may cause that portion of the core layer 140 to be more rigid.

As shown in FIG. 4A, the rearfoot portion 111 of the core layer 140 may include slits 143 extending to the edge 101 of the core layer 140. Such slits 140 help form the heel cup by allowing the portions of the core layer 140 between the slits 143 to easily bend upward to create the cup shape.

The core layer 140, including the above-described features, may be manufactured by injection molding. Different molds may be provided to manufacture different sizes of the core layer 140. Each of the molds includes an interior cavity that is the same size and shape as the core layer 140 to be injection molded. The internal cavity can further be shaped so as to form the core layer 140 with the variable thicknesses described above. For example, the interior cavity can be thinner where the core layer 140 is thinner and thicker where the core layer 140 is thicker. In some embodiments, the internal cavity of the mold also includes features to form the small holes 141 of the core layer, although, in other embodiments, the small holes 141 may be formed, for example, by punching, after the core layer 140 has been molded. The core layer 140 may also be manufactured by other methods. For example, the core layer 140 can be milled or 3-D printed.

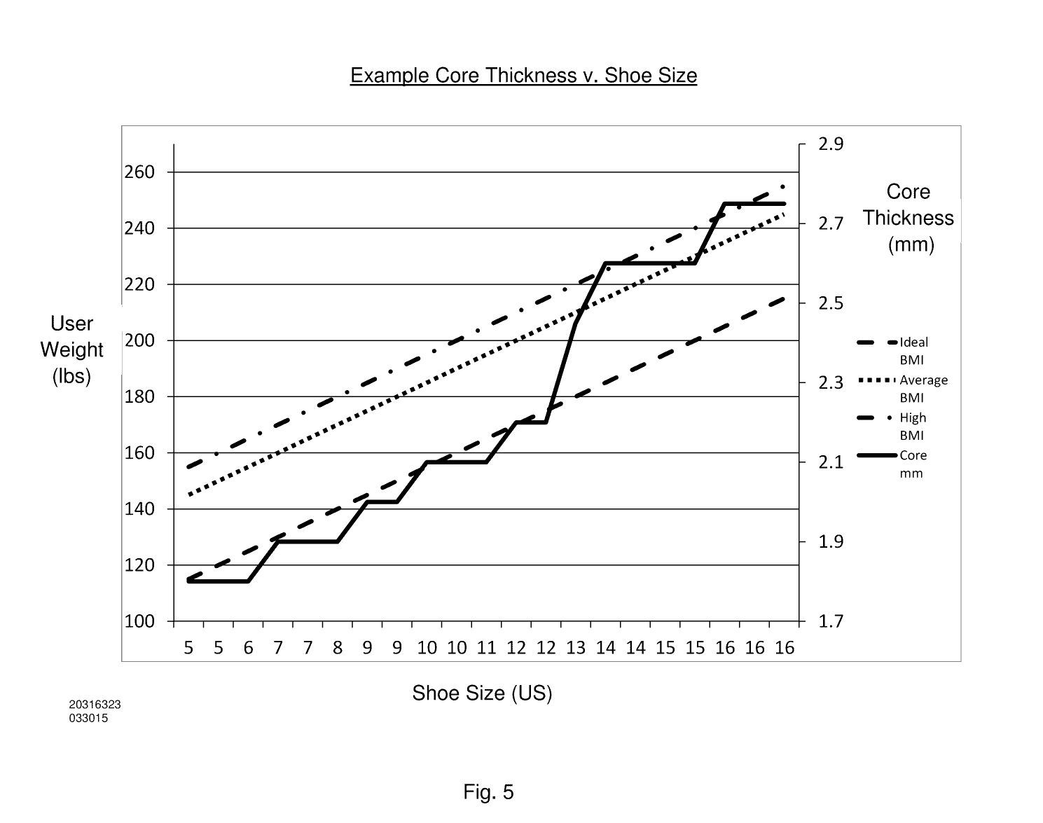

FIG. 5 is a chart that illustrates how the thickness of the core layer 140 can be selected to provide a proper level of support for users of different weights. It has been observed that, for the insole 100 to provide optimum support for users of different weights, the thickness of the core layer 140 may be selected to correspond to and provide adequate support for the weight of the particular user. For example, a heavier user may require a thicker core layer 140 because the thicker core layer 140 will be more rigid and provide greater support. Similarly, a lighter user may not need a thick core layer 140 and may be adequately supported by a thinner core layer 140. It has also been observed that there is a general correlation between the weight of a user and the shoe size of the user. Users with smaller feet tend to have a lighter weight and users with larger feet tend to have a heavier weight. Accordingly, a user's shoe size may serve as a rough estimator of the user's weight.

FIG. 5 illustrates that the thickness of the core layer should be adjusted to match the level of support required by a user. As illustrated by the trend lines representing ideal body mass index (BMI), average BMI, and high BMI, the core thickness required to support a user increases with shoe size. For example, a user with a size 7 shoe and an average BMI may require a core thickness between 2.1 mm and 2.3 mm to be adequately supported, while a user with a size 14 shoe and a high BMI may require a core thickness between 2.5 mm and 2.7 mm to be adequately supported.

In some embodiments, as shown in FIG. 5, the thickness of the core layer 140 increases with the shoe size with which the insole 100 will be used. For example, as shown in the chart, an insole 100 sized for use with a size five shoe has a core layer 140 with a thickness of approximately 1.8 mm. A core layer with a thickness of approximately 1.8 mm may provide optimal support for a user that weighs approximately 120 pounds. Similarly, an insole 100 sized for use with a size twelve shoe has a core layer 140 with a thickness of approximately 2.2 mm. A core layer 140 with a thickness of approximately 2.2 mm may provide optimal support for a user that weighs approximately 175 pounds. Finally, an insole 100 sized for use with a size sixteen shoe has a core layer 140 with a thickness of approximately 2.7 mm. A core layer 140 with a thickness of approximately 2.7 mm may provide optimal support for a user that weighs approximately 240 pounds. The previously described thicknesses of core layers 140 have been provided by way of example only, and a person of skill in the art will understand that the principles embodied in the chart in FIG. 5 may be modified to provide core layers 140 with different thicknesses than those described above. The thickness of the core layer 140 in the insole 100 can be selected based on the weight of the user, such that the core layer 140 provides optimal support for the user. In some embodiments, the selection of the thickness of the core layer 140 is made based on the size of the user's foot, the weight of the user, and/or the user's body mass index (BMI).

Moreover, the thickness of the core layer 140, described in reference to FIG. 5, may refer to either the thickness of a core layer 140 that has a uniform thickness, or it may be applicable to the maximum or average thickness of a core layer 140 that has a variable thickness, for example, as described above in reference to FIGS. 4A and 4B. For example, the core layer 140 may have a uniform thickness of approximately 2 mm for a lighter user or a uniform thickness of approximately 2.5 mm for a heavier user. Or, for example, the core layer 140 may have a variable thickness that varies in the range of approximately 1.0 mm to approximately 2.0 mm for a lighter user, or a variable thickness that varies in the range of approximately 1.5 mm to approximately 2.5 mm for a heavier user.

The moldable insole 100 as described herein may be molded with the molding devices and molding processes described in the U.S. Patent Application entitled “Apparatus and Method for Custom Molding an Insole” (Attorney Docket No. ZGI.003A) and can be reproduced by the molding systems and methods described in the U.S. Patent Application entitled “System and Method for Reproducing Molded Insole” (Attorney Docket No. ZGI.004A) concurrently filed with this application, both of which are incorporated herein by reference. Although, the insole 100 may also be molded using other molding systems and methods.

The advantages of the insole 100 as described herein include, but are not limited to, (1) the heat moldable material of the core layer 140, which both provides rigid support and can be heated to become moldable to conform to the specific shape of a foot, (2) the variable thickness and/or rigidity of the core layer 140, which may provide different levels of support at different regions of the insole 100 for different portions of the foot, and (3) the selection of the thickness of the core layer 140 depending on the specific weight of a user (where the selection of the thickness can either be a selection of a core layer 140 with a uniform thickness configured to provide support based on the weight of a user, or the selection of a variable thickness configured to provide support based on the weight of the user). These features allow the insole 100 to provide increased comfort, fit, and support over other insoles known in the art.

While the above description has pointed out features of various embodiments, the skilled person will understand that various omissions, substitutions, and changes in the form and details of the device or process illustrated may be made without departing from the scope of the appended claims.

What is claimed is:

1. A moldable footwear insole, comprising:
a cover layer configured to contact a foot;
a foam layer configured to contact a bottom side of the cover layer;
a core layer placed below and configured to contact at least a portion of the foam layer, the rigidity of the core layer varying at different locations of the core layer; and
a base layer sized and shaped to extend below and contact at least the core the core layer.

2. The moldable footwear insole of claim 1, wherein the core layer is sized and shaped to extend from below the heel portion of the foot to below the metatarsophalangeal joints of the foot.

3. The moldable footwear insole of claim 1, wherein the thickness of the core layer varies at different locations of the core layer in the range of approximately 1.0 mm to approximately 3.0 mm.

4. The moldable footwear insole of claim 3, wherein the core layer is thicker at an arch support region than at a heel region of the insole.

5. The moldable footwear insole of claim 4, wherein the thickness of the core layer tapers to a fine edge along the edges of the core layer.

6. The moldable footwear insole of claim 1, wherein the core layer is made from a heat-moldable or thermoplastic material, that is substantially pliable when heated to a temperature in the range of about 120° C. to about 140° C.

7. The moldable footwear insole of claim 6, wherein the heat-moldable or thermoplastic material comprises a glycol-modified polycyclohexylenedimethylene terephthalate copolymer (PCTG).

8. The moldable footwear insole of claim 1, wherein a plurality of through holes are formed in the core layer.

9. The moldable footwear insole of claim 1, wherein the cover layer comprises a flexible cloth material.

10. The moldable footwear insole of claim 1, wherein the foam layer comprises an EVA foam material.

11. The moldable footwear insole of claim 1, wherein the foam layer is approximately 4 mm thick.

12. The moldable footwear insole of claim 1, wherein the base layer comprises a flexible cloth material.

13. A moldable footwear insole, comprising:
a foam layer configured to provide cushioning for a foot; and
a core layer attached to a bottom side of the foam layer, the core layer comprising a heat moldable a glycol-modified polycyclohexylenedimethylene terephthalate copolymer (PCTG).

14. The moldable footwear insole of claim 13, wherein the thickness of the core layer varies in the range of between about 1.3 mm and 2.5 mm at different regions of the core layer.

15. The moldable footwear insole of claim 14, wherein the thickness of the core layer is greatest at an arch support region.

16. The moldable footwear insole of claim 15, wherein the thickness of the core layer tapers to a fine peripheral edge of each of a heel and toe region.

17. The moldable footwear insole of claim 13, wherein core layer has a uniform thickness.

18. The moldable footwear insole of claim 13, wherein the thickness of the core layer is selected based upon the weight of the user.

19. The moldable footwear insole of claim 13, wherein the core layer is configured to extend from below the heel of a foot to below the metatarsophalangeal joints of the foot.

20. A method for manufacturing a moldable footwear insole, the method comprising:
providing a cover layer including a first side and a second side, the first side configured to contact a foot;
placing first side of a foam layer in contact with the second side of the cover layer;
placing a core layer below the second side of the foam layer, wherein the thickness of the core layer varies at different locations of the core layer; and
covering the core layer with a base layer.

21. The method of claim 20, further comprising injection molding the core layer.

22. The method of claim 20, wherein the core layer comprises a heat moldable a glycol-modified polycyclohexylenedimethylene terephthalate copolymer (PCTG).

23. The method of claim 20, wherein the core layer is configured to extend from below the heel of a foot to below the metatarsophalangeal joints of a foot.

24. The method of claim 20, wherein the thickness of the core layer varies in the range of between about 1.3 mm to about 2.5 mm.

25. The method of claim 20, further comprising selecting the maximum thickness of the core layer based upon the weight of a user.
